(19) United States
(12) Patent Application Publication
(10) Pub. No.: US 2013/0292496 A1
(43) Pub. Date: Nov. 7, 2013

(54) MICRO FLOW CONTROL INJECTOR FOR USE IN ULTRAMICRO MONO-PROPELLANT BASED PNEUMATIC GENERATOR

(71) Applicants: Kyung-Soo Kim, Daejeon (KR); Soohyun Kim, Daejeon (KR); Kyungrok Kim, Daejeon (KR); Young June Shin, Daejeon (KR); Chang Wan Ha, Daejeon (KR); Jonghyun Lee, Daejeon (KR)

(72) Inventors: Kyung-Soo Kim, Daejeon (KR); Soohyun Kim, Daejeon (KR); Kyungrok Kim, Daejeon (KR); Young June Shin, Daejeon (KR); Chang Wan Ha, Daejeon (KR); Jonghyun Lee, Daejeon (KR)

(73) Assignee: KOREA ADVANCED INSTITUTE OF SCIENCE AND TECHNOLOGY, Daejeon (KR)

(21) Appl. No.: 13/489,810

(22) Filed: Jun. 6, 2012

(30) Foreign Application Priority Data
May 4, 2012 (KR) 10-2012-0047684

(51) Int. Cl. F02M 63/00

(52) U.S. Cl. 239/533.2

(57) ABSTRACT

Disclosed is a micro flow control injector for use in an ultramicro mono-propellant based pneumatic generator, including: a first check valve installed on a first supply pipe connected to a fuel tank charged with a mono-propellant and preventing a flow from the first supply pipe to the fuel tank; a small-sized driver connected with the first supply pipe and minutely controlling the supplied flow while repeatedly generating a decompression state and a pressurization state in the first supply pipe by a reciprocating movement; a second supply pipe connected to a cylinder of the small-sized driver to discharge fuel to a reactor in a pressurization state; and a second check valve installed on the second supply pipe and preventing a flow from the second supply pipe to the small-sized driver and the first supply pipe, in order to minutely control a flow.

### CROSS-REFERENCE TO RELATED APPLICATION

This application claims priority to and the benefit of Korean Patent Application No. 10-2012-0047684 filed in the Korean Intellectual Property Office on May 4, 2012, the entire contents of which are incorporated herein by reference.

### BACKGROUND OF THE INVENTION

(a) Field of the Invention

The present invention relates to a micro flow control injector for use in an ultramicro mono-propellant based pneumatic generator. More particularly, the present invention relates to a micro flow control injector for use in an ultramicro mono-propellant based pneumatic generator capable of supplying a mono-propellant to a reactor by precisely controlling the mono-propellant with a predetermined flow by means of a check valve and a low-power driver.

(b) Description of the Related Art

In general, since a pneumatic driver has higher power to weight than other drivers, and has a high reaction speed and high power, the pneumatic driver can be applied to a variety of fields. However, an air compressor capable of generating compressed air is required to use the pneumatic driver, and the air compressor is large in volume and weight thereof and is very noisy, thereby causing the use of the pneumatic driver to be limited.

An alternative having a structure such as a small-sized engine is proposed in order to solve the problems, but since the pneumatic driver still has a high noise level, the pneumatic driver is limitatively used.

A pneumatic generator that ejects fuel of a mono-propellant to a reactor by controlling a blow-down tank charged with the compressed air and a valve and generates pneumatic pressure with gas generated by reaction is proposed as the alternative, but since the compressed air for charging the blow-down tank and power for operating a lot of valves are required, energy efficiency deteriorates and the pneumatic generator still has the large volume.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a micro flow control injector for use in an ultramicro mono-propellant based pneumatic generator having advantages of minutely controlling a flow by using a small-sized driver that consumes low power, such as a small-sized motor or a piezoelectric element driver.

An exemplary embodiment of the present invention provides a micro flow control injector for use in an ultramicro mono-propellant based pneumatic generator, including: a first check valve installed on a first supply pipe connected to a fuel tank charged with a mono-propellant and preventing a flow from the first supply pipe to the fuel tank; a small-sized driver connected with the first supply pipe and minutely controlling the supplied flow while repeatedly generating a decompression state and a pressurization state in the first supply pipe by a reciprocating movement; a second supply pipe connected to a cylinder of the small-sized driver to discharge fuel to a reactor in a pressurization state; and a second check valve installed on the second supply pipe and preventing a flow from the second supply pipe to the small-sized driver and the first supply pipe.

The small-sized driver may be configured by using a low-power driver selected from a low-power motor, a piezoelectric driver, and a thermal strain driver.

According to the exemplary embodiment of the present invention, since the micro flow control injector for use in an ultramicro mono-propellant based pneumatic generator uses a low-power small-sized driver, the micro flow control injector is very efficient, and can be small-sized and lightened.

In addition, since a driving principle of supplying fuel to a reactor is simple and intuitive, additional complicated control logic is not required and is easily used.

Furthermore, since the micro flow control injector has a low-noise characteristic, a noise problem of a pneumatic driver in the related art can be solved and a range of application can be widened.

### BRIEF DESCRIPTION OF THE DRAWINGS

FIG. 1 is a cross-sectional view conceptually illustrating a micro flow control injector for use in an ultramicro mono-propellant based pneumatic generator according to an exemplary embodiment of the present invention.

FIG. 2 is a 3D modeling perspective view conceptually illustrating the micro flow control injector for use in an ultramicro mono-propellant based pneumatic generator according to the exemplary embodiment of the present invention.

FIG. 3 is a block diagram conceptually illustrating a pneumatic generator adopting the micro flow control injector for use in an ultramicro mono-propellant based pneumatic generator according to the exemplary embodiment of the present invention.

FIG. 4 is a 3D modeling perspective view schematically illustrating a state of using a low-power motor in the micro flow control injector for use in an ultramicro mono-propellant based pneumatic generator according to the exemplary embodiment of the present invention.

### DETAILED DESCRIPTION OF THE EMBODIMENTS

Next, an exemplary embodiment of a micro flow control injector for use in an ultramicro mono-propellant based pneumatic generator according to the present invention will be described in detail with reference to the accompanying drawings.

The present invention can be implemented in various forms and is not limited to exemplary embodiments to be described below.

Hereinafter, a detailed description of a part which is not closely associated with the present invention will be omitted in order to clearly describe the present invention and like reference numeral will refer to like elements throughout the specification and a duplicated description will be omitted.

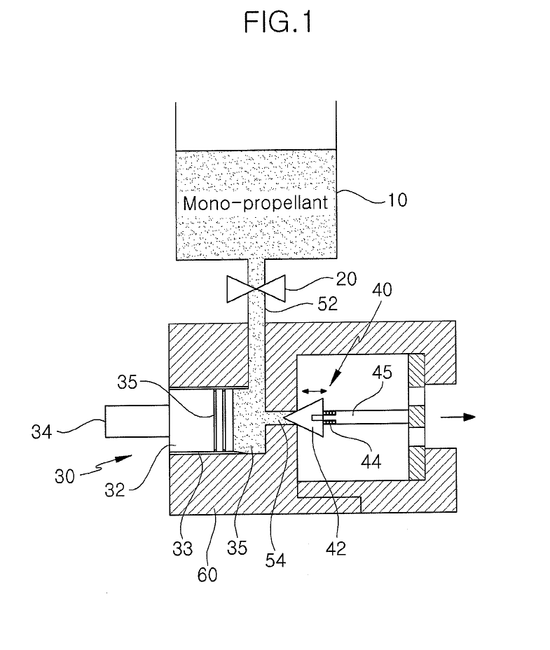

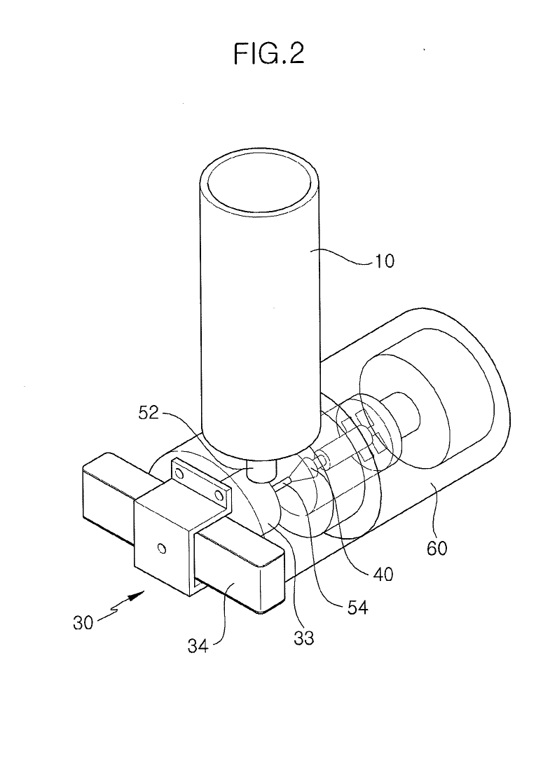

First, a micro flow control injector for use in an ultramicro mono-propellant based pneumatic generator according to an exemplary embodiment of the present invention includes a first check valve 20, a small-sized driver 30, and a second check valve 40, as illustrated in FIGS. 1 and 2.

The first check valve 20 is installed on a first supply pipe 52 connected to a fuel tank 10 charged with a mono-propellant.

The first check valve 20 serves to prevent the flow from the first supply pipe 52 to the fuel tank 10. That is, the first check valve 20 serves to maintain the flow in which the mono-propellant is discharged from the fuel tank 10 to the first supply pipe 52, but prevent a reverse-direction flow.

The mono-propellant charged in the fuel tank 10 may be selected from hydrogen peroxide (H₂O₂), hydrazine (N₂H₄), and nitrous oxide (N₂O).

The small-sized driver 30 is installed to be connected with the first supply pipe 52, and serves to repeatedly generate a decompression state and a pressurization state in the first supply pipe 52 by a reciprocating movement.

The small-sized driver 30 is installed with a space of a cylinder 33 to be in communication with an inner part of the first supply pipe 52.

A piston 32 is inserted into the cylinder 33 to reciprocatively move

In addition, the piezoelectric element driver 34 that applies force for reciprocatively moving to the piston 32 is connected onto the piston 32.

The piston 32 may be sealed to prevent the mono-propellant from leaking by using an O-ring 35 or a mechanical seal.

A low-power motor 37 may be connected onto the piston 32 as illustrated in FIG. 4.

When the low-power motor 37 is connected onto the piston 32, a crank-slider mechanism 38 may be installed between the piston 32 and the low-power motor 37.

The small-sized driver 30 may be configured by using various low-power drivers such as a thermal strain driver in addition to the low-power motor 37 and the piezoelectric element driver 34.

The cylinder 33 of the small-sized driver 30 is installed to be in communication with a second supply pipe 54.

The first supply pipe 52 and the second supply pipe 54 are arranged with the space of the cylinder 33 being positioned between the first supply pipe 52 and the second supply pipe 54.

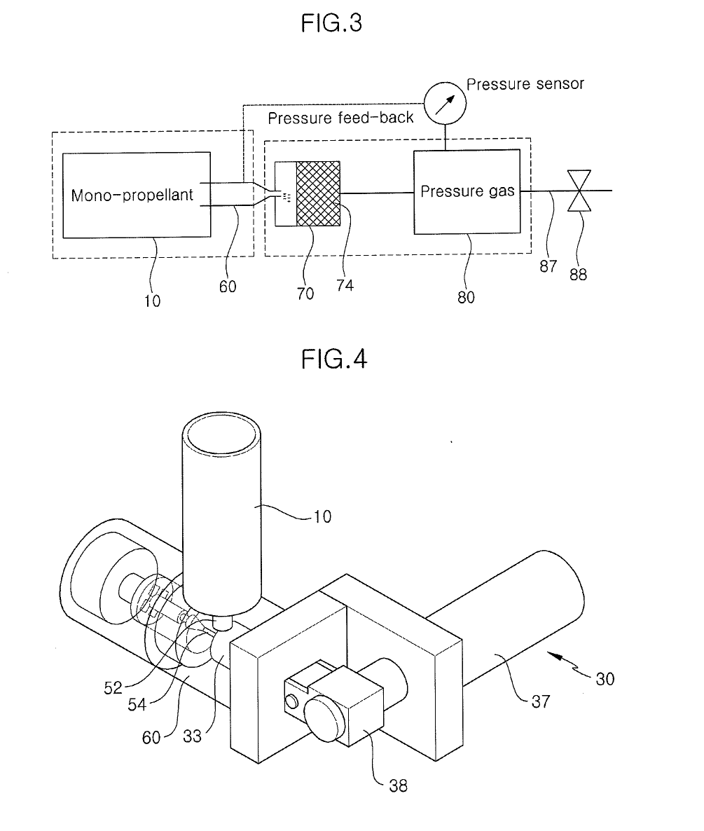

As illustrated in FIG. 3, the second supply pipe 54 is connected onto a reactor 70.

Therefore, the second supply pipe 54 serves to guide the flow so as to move the mono-propellant that moves through the first supply pipe 52 to the reactor 70.

The second check valve 40 is installed on the second supply pipe 54. The second check valve 40 serves to prevent a flow from the second supply pipe 54 to the cylinder 33 of the small-sized driver 30 and the first supply pipe 52.

The second check valve 40 includes a valve body 42 opening or closing the second supply pipe 54, a support member 45 supporting the valve body 42, and an elastic member 44 installed on the support member 45 and applying force in a direction to close the second supply pipe 54 to the valve body 42.

The mono-propellant that flows out to the first supply pipe 52 flows into the second supply pipe 54 according to the operation of the small-sized driver 30 configured as above.

For example, when the piston 32 of the small-sized driver 30 moves backward, the inner part of the cylinder 33 and the inner part of the first supply pipe 52 are in the decompression state, the second check valve 40 is in a closed state, and the first check valve 20 is in an opened state, such that the mono-propellant of the fuel tank 10 is supplied to the first supply pipe 52.

In the above state, when the piston 32 of the small-sized driver 30 moves forward again, the inner part of the cylinder 33 and the inner part of the first supply pipe 52 are in the pressurization state, the first check valve 20 is in the closed state, and the second check valve 40 is in the opened state, such that some of the mono-propellant in the first supply pipe 52 and the cylinder 33 moves to the reactor 70 through the second supply pipe 54.

As the inner part of the cylinder 33 and the inner part of the first supply pipe 52 are in the pressurization state, pressure is transferred to the second check valve 40 through the second supply pipe 54 and the transferred pressure is larger than elastic force of the elastic member 44, such that the valve body 42 moves in a direction to be distant from the small-sized driver 30 over the elastic force and the second supply pipe 54 is changed from the close state to the opened state.

As the small-sized driver 30 operates, the decompression state and the pressurization state repeatedly occurs in the first supply pipe 52, and the mono-propellant of the fuel tank 10 is pressure-fed to the reactor 70 by sequentially passing through the first supply pipe 52 and the second supply pipe 54.

In the small-sized driver 30, a minimum flow may be changed and set depending on vibration displacement and an area, a type and an output of the piston 32, and the small-sized driver 30 may be changed and designed according to maximum generation pneumatic pressure and a pneumatic pressure generation speed.

Therefore, when the small-sized driver 30 is used, the flow supplied to the reactor 70 through the second supply pipe 54 may be minutely controlled. For example, since the flow supplied to the reactor 70 through the second supply pipe 54 may be variably controlled from a unit of several μl/sec to a unit of tens of μl/sec, the small-sized driver 30 may be designed according to the use and widely used.

A flow V_{flow} controlled through the small-sized driver 30 is determined by a vibration speed f of the small-sized driver 30, a cross-sectional area A of the piston 32, and a vibration amplitude L and may be represented by V_{flow}=f*A*L. Herein, the vibration speed f represents a reciprocating speed of the piston 32, and the vibration amplitude L represents a stroke which is a movement distance of the piston 32

The cylinder 33 of the small-sized driver 30, the first supply pipe 52, and the second supply pipe 54 may be modulated with being mounted on one case 60 as illustrated in FIGS. 2 and 4.

The micro flow control injector for use in the ultramicro mono-propellant based pneumatic generator according to the exemplary embodiment of the present invention configured as above is installed between the fuel tank 10 and the reactor 70 as illustrated in FIG. 3.

A catalyst 73 which reacts with the mono-propellant charged in the fuel tank 10 is installed in the reactor 70.

A pneumatic tank 80 forming pneumatic pressure by storing generated gas is connected to the reactor 70.

An opening/closing valve 88 is configured to be installed on a pneumatic pipe 87 connected to the pneumatic tank 80 to supply the pneumatic pressure as necessary.

While the micro flow control injector for use in an ultramicro mono-propellant based pneumatic generator according to this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10—Fuel tank, 20—First check valve, 30—Small-sized driver, 32—Piston

33—Cylinder, 34—Piezoelectric element driver, 35—O-ring, 37—Low-power motor

38—Crank-slider mechanism, 40—Second check valve, 42—Valve body, 44—Elastic member

45—Support member, 52—First supply pipe, 54—Second supply pipe, 60—Case

70—Reactor, 74—Catalyst, 80—Pneumatic tank, 87—Pneumatic pipe, 88—Opening/closing valve

What is claimed is:

1. A micro flow control injector for use in an ultramicro mono-propellant based pneumatic generator, comprising:
a first check valve installed on a first supply pipe connected to a fuel tank charged with a mono-propellant and preventing a flow from the first supply pipe to the fuel tank;
a small-sized driver connected with the first supply pipe and minutely controlling the supplied flow while repeatedly generating a decompression state and a pressurization state in the first supply pipe by a reciprocating movement;
a second supply pipe connected to a cylinder of the small-sized driver to discharge fuel to a reactor in a pressurization state; and
a second check valve installed on the second supply pipe and preventing a flow from the second supply pipe to the small-sized driver and the first supply pipe.

2. The micro flow control injector for use in an ultramicro mono-propellant based pneumatic generator of claim 1, wherein:
the small-sized driver is configured by using a low-power driver selected from a low-power motor, a piezoelectric driver, and a thermal strain driver.

3. The micro flow control injector for use in an ultramicro mono-propellant based pneumatic generator of claim 2, wherein:
the small-sized driver is installed with a space of the cylinder being in communication with an inner part of the first supply pipe,
a piston inserted and installed into the cylinder to reciprocatively move, and
the low-power driver applying force for reciprocation to the piston is connected and installed onto the piston.

4. The micro flow control injector for use in an ultramicro mono-propellant based pneumatic generator of claim 3, wherein:
the piston is sealed by using an O-ring or a mechanical seal so as to prevent the mono-propellant from leaking.

5. The micro flow control injector for use in an ultramicro mono-propellant based pneumatic generator of claim 1, wherein:
the second check valve includes a valve body opening or closing the second supply pipe, a support member supporting the valve body, and an elastic member installed on the support member and applying force in a direction closing the second supply pipe to the valve body.
